(19) United States
(12) Patent Application Publication
(10) Pub. No.: US 2025/0260713 A1
(43) Pub. Date: Aug. 14, 2025

(54) REQUEST ISOLATION SYSTEM

(71) Applicant: SAP SE, Walldirf (DE)

(72) Inventors: Nicolas SCHAEFER, Mannheim (DE); Sven Sterbling, Heidelberg (DE)

(21) Appl. No.: 18/439,931

(22) Filed: Feb. 13, 2024

(51) Int. Cl. H04L 9/40

(52) U.S. Cl. CPC H04L 63/1441; H04L 63/1416

(57) ABSTRACT

System, method, and various embodiments for a request isolation system are described herein. An embodiment operates by determining a first request that has been processed by one or more computing services of a primary computing system. It is determined that processing resources used in processing the first request have exceeded a first computing threshold for the first request. It is determined that the first request is malicious based on the determination that the processing resources exceed the first computing threshold. A client of the primary computing system from which the malicious request was received is identified, a second request is received from the client, and the second request is routed to a secondary computing system for processing based on the determination that the first request was malicious.

### BACKGROUND

Malicious requests can range external attacks to requests that consume a large amount of computing resources. Computing systems need to have some way to manage, handle, and identify malicious requests. However, not all malicious requests are made equal. While some computing systems may stop processing any and all requests deemed malicious, this is not always a suitable response.

### BRIEF DESCRIPTION OF THE DRAWINGS

The accompanying drawings are incorporated herein and form a part of the specification.

FIG. 1 is a block diagram illustrating example functionality for a request isolation system (RIS), according to some embodiments.

FIG. 2 is a flowchart illustrating example operations for providing a request isolation system (RIS), according to some embodiments.

FIG. 3 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a request isolation system.

Malicious requests can range external attacks to requests that consume a large amount of computing resources. Computing systems need to have some way to manage, handle, and identify malicious requests. However, not all malicious requests are made equal. While some computing systems may stop processing any and all requests deemed malicious, this is not always a suitable response.

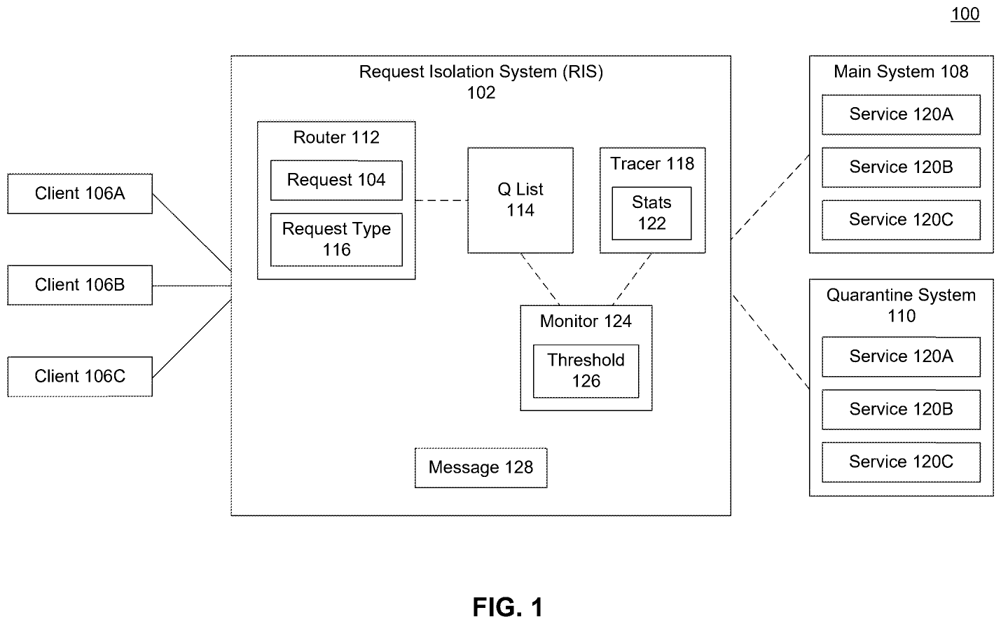

FIG. 1 is a block diagram 100 illustrating example functionality for a request isolation system (RIS) 102, according to some embodiments. RIS 102 may help increase computing system throughput of a first computing system by identifying malicious requests and routing both malicious requests and potentially malicious requests to a backup or secondary computing system until the threat has been reduced or absolved. RIS 102 enables both normal and malicious requests to be processed, but without the malicious requests interfering with the timely processing of normal requests.

In some embodiments, RIS 102 may receive a request 104 from various clients 106A-C. Request 104 may include one or more processing requests to be handled by a main computing system 108. For simplicity, a single request 104 is illustrated, however it is understood that RIS 102 may receive multiple requests in parallel from various clients 106A-C. As such, the terms request 104 and requests 104 may be used interchangeably. The requests 104 may include a variety of different request types 116 such as read or write requests, or requests or commands to perform a specific functionality. In other embodiments, there may be other or different request types 116.

Clients 106A-C may include various organizations and/or computing systems or devices that submit requests 104. In some embodiments, each client 106A-C may represent multiple computing devices any one of which may submit a request 104 to RIS 102. The term client 106 may be used to generally to refer to any combination of one or more clients 106A-C. In other embodiments, more than three clients 106 may be capable of submitting requests 104.

In some embodiments, the request 104 may be received by a router 112. Router 112 may be a computing system or computing device configured to route the request 104 to either main computing system 108 or a quarantine computing system 110 for processing. In some embodiments, router 112 may be a standalone device communicatively coupled over a wired or wireless network to RIS 102.

In some embodiments, router 112 may have access to a quarantine list (Q list) 114. Q list 114 may include a record indicating which request(s) 104 and/or which requests 104 from which clients 106 are to be directed to quarantine system 110. In some embodiments, Q list 114 may include a black list of which requests 104 are to be directed to quarantine system 110, a white list of which requests 104 are allowed to be directed to main system 108, or a black and white list of both.

For simplicity, in the examples used herein, the Q list 114 will be described as indicating which requests 104 are to be directed to the quarantine system 110. In some embodiments, the Q list 114 may indicate a list of clients 106 for whom requests 104 received from those client(s) 106 are to be directed to the quarantine system 110 instead of the main system 108.

In some embodiments, the Q list 114 may include a list of internet protocol (IP) addresses, MAC (media access control) addresses, names, domains, or other client identifiers. In some embodiments, the Q list 114 may indicate a request type 116. For example, only write requests from client 106C may be directed to quarantine system 110, while read requests or other types of requests may be directed to main system 108.

In some embodiments, as part of processing, router 112 or RIS 102 may detect or identify both a source of the request 104 (e.g., which client 106 the request 104 originated), and a request type 116 of the request 104. Then, based on this information, cross referenced with Q list 114, router 112 may route the request 104 to either main system 108 or quarantine system 110 for processing.

Main system 108 may include a computing system comprising one or more computing devices, including but not limited to servers and a database, that are configured to perform one or more services 120A-C. The services 120A-C, referred to herein generally as services 120, may include applications, programs, or other functionality that may be requested or may be executed as part of processing a request 104. Example services 120 include, but are not limited to, an authentication service, database read, database write, video generation, data transformations, etc. In some embodiments, different requests 104 or different request types 116 may access only a subset of the available services 120. That is, each request 104 may not use every service 120.

In some embodiments, main system 108 may be used during normal processing of requests 104 from clients 106. However, as described in greater detail below, some requests 104 may consume more than a normal range of computing power, computing resources, computing cycles, or computing time. These requests may be deemed malicious requests, even if they are received from an authorized client 106. These malicious requests may indicate the beginning of an attack, or an inadvertent, innocent, or legitimate request from a client 106.

When a malicious request is identified as coming from a particular client 106C, future requests 104 from the client may be directed to a quarantine system 110 for processing, instead of main system 108. In some embodiments, quarantine system 110 may include the same services 120A-C as available with main system 108, however quarantine system 110 may be allocated fewer resources and may operate independently (e.g., using different computing devices) from main system 108, such that processing of malicious or potentially malicious requests 104 by quarantine system 110 does not impact the speed and throughput of main system 108 processing requests 104.

In some embodiments, if there is a shared computing resource (e.g., such as a computing device or database) between main system 108 and quarantine system 110, the requests from quarantine system 110 may assigned a lower priority relative to requests from main system 108, and/or the requests from quarantine system 110 may be executed with a specific timeout period, so as not to slow processing of requests 104 from main system 108.

Using, this dual system setup, may allow an organization, such as a cloud computing system, to continue processing requests 104 from clients 106A-C, without allowing malicious requests to slow the processing of normal requests 104. Further, quarantine system 110 may allocated with fewer computing resources relative to main system 108, so that there is a cost savings relative to maintaining two identical systems. Various embodiments, in which malicious requests are identified and how requests may be moved between main system 108 and quarantine system 110 are described in greater detail below.

In some embodiments, RIS 102 may be configured to perform a tracing of how requests 104 are processed by main system 108 and quarantine system 110, using a tracer 118. In some embodiments, tracer 118 may perform distributed tracing of a request 104 as it is processed or causes processing by various services 120A-C. In some embodiments, the tracing may include tracking various metrics or other types of information such as events that are logged while a request 104 is executed, structural information about which services 120A-C were traversed, and how much time was spent on each service 120A-C. The results of the tracing may be stored as statistics (stats 122). In some embodiments, tracer 118 may employ sampling to generate stats 122.

Stats 122 may include any metrics that are collected from the tracing performed by tracer 118. In some embodiments, the stats 122 may include the amount of resource consumption, the time it took to process a request 104 by each or a combination of services 120A-C, and/or error codes or other intermediate output that may have been generated during the processing of a request 104, or other metrics.

In some embodiments, tracer 118 or a monitor 124 may generate a threshold 126. Threshold 126 may indicate a range of normal processing and/or malicious processing, and may be generated based on stats 122. For example, RIS 102 may collects stats 122 for a period of time, and generate a range of normal processing (e.g., normal time or computing resources it takes to process a request 104 by each service 120A-C or a combination of services 120A-C, or specific type of request 104, by one or more of the services 120A-C). RIS 102 may then define a threshold 126 indicating that any request 104 that consumes more than the normal time or computing resources is to be deemed a malicious request.

A malicious request may include any request or requests 104 that consume more than the threshold 126 amount of time or resources (by one or more services 120), even if received from an authorized source or client 106. In some embodiments, threshold 126 may include a collection of values that signify thresholds. For example, threshold 126 may indicate that the average processing time for a request 104 is 10 seconds, 5 seconds and 3 seconds across services 120A-C, respectively, and that any request 104 that exceeds 11seconds, 6 seconds, and 4 seconds, respectively is to be determined a malicious request.

In some embodiments, threshold 126 may further indicate that at least two of the three (or more than 50%) of the service thresholds may need to be exceeded for the request to be determined as malicious. For example, if a request 104 takes 13 seconds, 5 seconds, and 2 seconds, the request 104 may not be malicious. Or, for example, threshold 126 may indicate that any request 104 causing any service 120 to exceed the threshold 126 for that service 120 may be enough to deem the request as malicious.

In some embodiments, threshold 126 may also indicate how many malicious requests from a particular client (and/or of a particular request type 116) are allowed in a certain period of time, or over a range of requests before the client is deemed malicious. In some embodiments, a single malicious request 104 may be enough to deem the client as malicious and add the client to the Q list 114. In some embodiments, if RIS 102 detects 2 malicious requests 104 within a 24 hour period of time, or over 100 requests that are processed, the client 106 may be deemed as malicious. Then, for example, monitor 124 may maintain a count of how many malicious requests are identified from each client 106 and over what period of time or over how many requests. In other embodiments, other thresholds 126 and/or threshold combinations may be used.

Once monitor deems a client 106 as malicious, based on one or more requests 104 from the client 106 exceeding threshold 126, the client may be added to Q list 114. In some embodiments, the monitor 124 may further specify a request type 116 to add to Q list 114 for the malicious client, such that only those types of requests are routed to quarantine system 110. So, if a new request 104 is received from the malicious client 106, the request type 116 of new request 104 may be checked, and if the same request type 116 for that client 106 is located on the Q list 114, the new request 104 may be routed to the quarantine system 110. If the request type 116 for any new requests 104 is not on the Q list 114, then those new requests 104 may be processed by the main system 108.

In some embodiments, Q list 114 may indicate that all requests 104 from a malicious client are directed to quarantine system 110. Then, as noted above, when a subsequent request 104 is received from a malicious client (e.g., client 106), those requests 104 may be routed to quarantine system 110, instead of main system 108.

As noted above, tracer 118 may continue tracing or monitoring how malicious requests from a client 106 are being processed by quarantine system 110. This tracing of quarantine system 110 may include its own set of metrics and stats 122, similar to those described above. This tracing may allow RIS 102 to add and remove clients 106 from Q list 114. For example, if the tracing reveals that the subsequent requests from a malicious client are within a threshold 126, then, RIS 102 may remove the client from the Q list 114, and any further requests 104 from the client may be directed back to main system 108.

In some embodiments, a first threshold 126 may indicate when a client 106 (and corresponding request type 116 in some embodiments) is placed onto the Q list 114, and a second threshold 126 may indicate when the client 106 (and corresponding request type 116) is removed from the Q list 114. In some embodiments, the first and second thresholds 126 may be identical, while in other embodiments, the values for the first and second threshold 126 may vary.

In some embodiments, one a client 106 is moved to Q list 114 it may be required to remain on Q list 114 for a specific period of time (e.g. 1 hour) or for a minimum number of requests (e.g., 50 requests) before it is eligible to be removed from Q list 114. Once the required time period has expired, monitor 124 may determine if the stats 122 from tracing the processing of the malicious requests from the client 106 as processed by quarantine system 110 are below the threshold 126. If the stats 122 are below the threshold 126, then the client may be removed from Q list 114. If the stats 122 continue to exceed the threshold 126, then the minimum period may be reset.

In some embodiments, threshold 126 may include a suspension threshold, such that is requests from a malicious client 106 generate stats 122 exceeding threshold 126 for a certain period of time, requests 104 from the client may be suspended and/or a network administrator may be notified of a possible threat condition.

In some embodiments, a malicious request may share or use one or more services 120A-C from main system 108 and one or more services 120A-C from quarantine system 110. For example, if a write request from client 106B operates normally on service A and service C, but exceeds threshold 126 for service B, then, the subsequent write requests from client 106B may be use service 120A and 120C from main system 108 and service 120B from quarantine system 110. In some embodiments, service 120A may be an authentication service which may be used by all requests, and service 120A may not exist on quarantine system 110, thus minimizing the amount of duplication necessary.

In some embodiments, RIS 102 may be in communication with other similarly arranged computing systems (not shown) similar to system 100. For example, the system 100 may be the New York processing location, but there may also be an Austin processing location and a Los Angeles processing system. The Austin location may receive and process requests from client 106B, and other clients (not shown), and the Los Angeles location may receive and process requests from all of clients 106A-C.

Then, for example, if client 106B is deemed as malicious by the New York system, RIS 102 may generate and provide a message 128 to both the Austin location and the Los Angeles location to treat requests from client 106B as malicious and to add the client 106B to their respective Q lists 114. If client 106C is deemed as malicious, message 128 may only be transmitted to the Los Angeles location, since Austin does not process requests from client 106C. Then, for example, whichever system receives the message 128, may begin routing requests from the malicious client to their own local quarantine system, instead of processing those requests on their own local main system.

In some embodiments, different main systems 108 may share a dedicated quarantine system 110. For example, both Los Angeles and New York may share the same quarantine system 110, such that requests received at Los Angeles main system that are determined to be quarantined, may be provided to the same dedicated quarantine system 110 as quarantined requests received at the New York main system. In some embodiments, the main systems 108 and quarantine systems 110 across different locals may vary from each other in their configuration, except that the quarantine systems 110 may be isolated from the main systems 108 and be allocated with less computing power or resources relative to the main system 108.

This messaging may help prevent widespread slowdowns or attacks caused by the malicious client(s) 106B or 106C. Then, for example, each location may independently monitor the quarantine system 110 processing to determine when to remove the client from their respective Q lists 114. In some embodiments, the other locations (Austin, Los Angeles) may wait until they receive a subsequent message 128 from New York (the originating location) indicating that New York has removed the client from the Q list 114, and then the locations may continue with normal processing of requests from the client (e.g., removing the client from their own local Q lists 114).

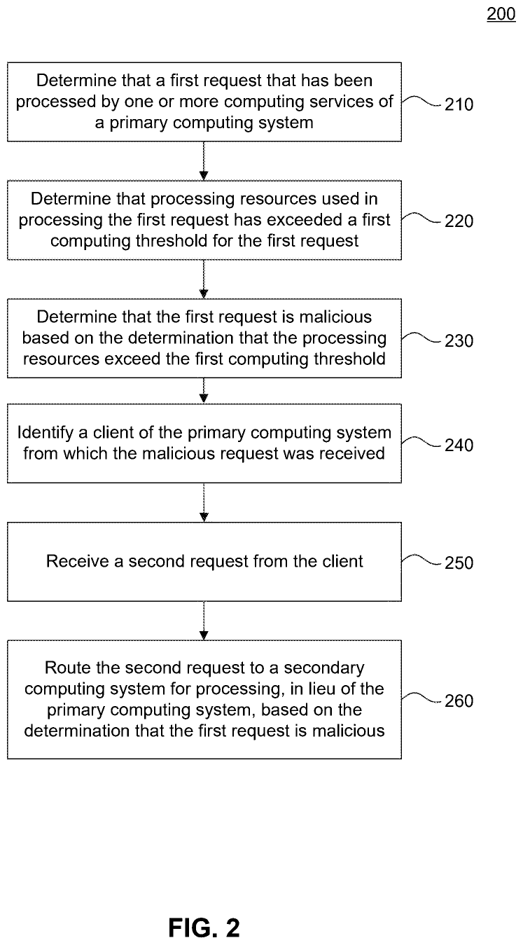

FIG. 2 is a flowchart 200 illustrating example operations for providing a request isolation system (RIS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1.

In 210, it is determined that a first request that has been processed by one or more computing services of a primary computing system. For example, RIS 102 may receive request 104 from a client 106A, and router 112 may transmit the request 104 to main system 108 for processing.

In 220, it is determined that processing resources used in processing the first request has exceeded a first computing threshold for the first request. For example, tracer 118 may trace the processing of request 104 by the various services 120A-C of main system 108, and collect stats 122 about the processing.

In 230, it is determined that the first request is malicious based on the determination that the processing resources exceed the first computing threshold. For example, monitor 124 may determine that the stats 122 of main system 108 processing request 104 exceed one or more thresholds 126, on a service-level and/or overall system throughput or multiple-service level. This determination that some subset of the stats 122 for processing the request 104 exceed one or more thresholds 126, may cause monitor to deem the request 104 as being malicious.

In 240, a client of the primary computing system from which the malicious request was received, is identified. For example, monitor 124 may add client 106A to the Q list 114. In some embodiments, monitor 124 may determine the request type 116, and add both client 106A and the corresponding request type 116 for the malicious request to the Q list 114. In some embodiments, a message 128 may be transmit to other systems that may be receiving requests from client 106A, that client 106A is potentially malicious.

In 250, a second request is received from the client. For example, RIS 102 may receive a second or subsequent request from client 106 at router 112.

In 260, the second request is routed to a secondary computing system for processing, in lieu of the primary computing system, based on the determination that the first request is malicious. For example, router 112 may check the client 106A (and in some embodiments, request type 116) against the Q list 114, and route the second request to the quarantine system 110. RIS 102 may continue monitoring the processing of both main system 108 and quarantine system 110, and continue to add/remove clients 106 and/or request types 116 from the Q list 114.

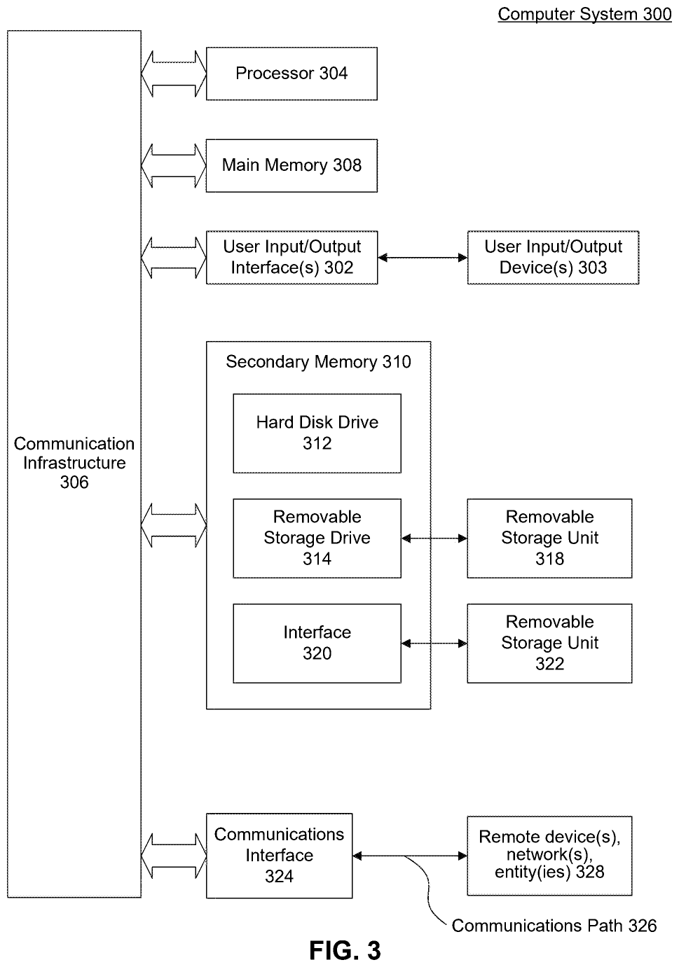

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
determining a first request that has been processed by one or more computing services of a primary computing system;
determining that processing resources used in processing the first request have exceeded a first computing threshold for the first request;
determining that the first request is malicious based on the determination that the processing resources exceed the first computing threshold;
identifying a client of the primary computing system from which the malicious request was received;
receiving a second request from the client; and
routing the second request to a secondary computing system for processing, in lieu of the primary computing system, based on the determination that the first request is malicious.

2. The method of claim 1, wherein the secondary computing system comprises fewer computing resources relative to the primary computing system, and wherein the second computing system operates the one or more computing services with the fewer computing resources.

3. The method of claim 1, further comprising:
determining that the first request comprises a first type of request from a plurality of request types; and
determining that the second request comprises the first type of request.

4. The method of claim 3, further comprising:
receiving a third request from the client;
determining that the third request is a second type of request from the plurality of request types; and
routing the third request to the primary computing system, in lieu of the secondary computing system, based on the determination that the third request is the second type of request and the determination that the first request is malicious.

5. The method of claim 1, further comprising:
determining, after the routing, that processing resources used by the secondary computing system in processing the second request are below a second computing threshold; and
routing a third request received from the client to the primary computing system, in lieu of the secondary computing system, based on the determination that the second request is below the second computing threshold.

6. The method of claim 5, wherein the first computing threshold and the second computing threshold are identical.

7. The method of claim 1, further comprising:
providing a message to a third computing system configured to receive requests from the client indicating that the first request, from the client, is malicious, wherein the third computing system is configured to route a subsequent request received from the client to a fourth computing system responsive to receiving the message.

8. The method of claim 1, wherein the determining that processing resources used in processing the first request have exceeded the first computing threshold for the first request comprises:
receiving statistics about which processing resources were used in processing the first request based on a trace of the first request as it was processed by the first computing system.

9. A system comprising:
a memory; and
at least one processor coupled to the memory and configured to perform operations comprising:
determining a first request that has been processed by one or more computing services of a primary computing system;
determining that processing resources used in processing the first request have exceeded a first computing threshold for the first request;
determining that the first request is malicious based on the determination that the processing resources exceed the first computing threshold;
identifying a client of the primary computing system from which the malicious request was received;
receiving a second request from the client; and
routing the second request to a secondary computing system for processing, in lieu of the primary computing system, based on the determination that the first request is malicious.

10. The system of claim 9, wherein the secondary computing system comprises fewer computing resources relative to the primary computing system, and wherein the second computing system operates the one or more computing services with the fewer computing resources.

11. The system of claim 9, the operations further comprising:
determining that the first request comprises a first type of request from a plurality of request types; and
determining that the second request comprises the first type of request.

12. The system of claim 11, the operations further comprising:
receiving a third request from the client;
determining that the third request is a second type of request from the plurality of request types; and
routing the third request to the primary computing system, in lieu of the secondary computing system, based on the determination that the third request is the second type of request and the determination that the first request is malicious.

13. The system of claim 9, the operations further comprising:
determining, after the routing, that processing resources used by the secondary computing system in processing the second request are below a second computing threshold; and
routing a third request received from the client to the primary computing system, in lieu of the secondary computing system, based on the determination that the second request is below the second computing threshold.

14. The system of claim 13, wherein the first computing threshold and the second computing threshold are identical.

15. The system of claim 9, the operations further comprising:
providing a message to a third computing system configured to receive requests from the client indicating that the first request, from the client, is malicious, wherein the third computing system is configured to route a subsequent request received from the client to a fourth computing system responsive to receiving the message.

16. The system of claim 9, wherein the determining that processing resources used in processing the first request have exceeded the first computing threshold for the first request comprises:
receiving statistics about which processing resources were used in processing the first request based on a trace of the first request as it was processed by the first computing system.

17. A non-transitory computer-readable medium having instructions stored thereon that, when executed by at least one computing device, cause the at least one computing device to perform operations comprising:
determining a first request that has been processed by one or more computing services of a primary computing system;
determining that processing resources used in processing the first request have exceeded a first computing threshold for the first request;
determining that the first request is malicious based on the determination that the processing resources exceed the first computing threshold;
identifying a client of the primary computing system from which the malicious request was received;
receiving a second request from the client; and
routing the second request to a secondary computing system for processing, in lieu of the primary computing system, based on the determination that the first request is malicious.

18. The non-transitory computer-readable medium of claim 17, wherein the secondary computing system comprises fewer computing resources relative to the primary computing system, and wherein the second computing system operates the one or more computing services with the fewer computing resources.

19. The non-transitory computer-readable medium of claim 17, the operations further comprising:
determining that the first request comprises a first type of request from a plurality of request types; and
determining that the second request comprises the first type of request.

20. The non-transitory computer-readable medium of claim 19, the operations further comprising:
receiving a third request from the client;
determining that the third request is a second type of request from the plurality of request types; and
routing the third request to the primary computing system, in lieu of the secondary computing system, based on the determination that the third request is the second type of request and the determination that the first request is malicious.
